(19) United States
(12) Patent Application Publication
(10) Pub. No.: US 2013/0275022 A1
(43) Pub. Date: Oct. 17, 2013

(54) ENGINE CRANK SIGNAL CORRECTION METHOD AND CONTROLLER

(71) Applicants: SALEM AHMAD FAYYAD, GRAND BLANC, MI (US); ANDY TENKA, YPSILANTI, MI (US); KENNETH M SIMPSON, SWARTZ CREEK, MI (US); JON C. DARROW, BRIGHTON, MI (US); MICHAEL J. FREY, KOKOMO, IN (US)

(72) Inventors: SALEM AHMAD FAYYAD, GRAND BLANC, MI (US); ANDY TENKA, YPSILANTI, MI (US); KENNETH M SIMPSON, SWARTZ CREEK, MI (US); JON C. DARROW, BRIGHTON, MI (US); MICHAEL J. FREY, KOKOMO, IN (US)

(73) Assignee: DELPHI TECHNOLOGIES, INC., TROY, MI (US)

(21) Appl. No.: 13/445,103

(22) Filed: Apr. 12, 2012

(51) Int. Cl. F02D 28/00

(52) U.S. Cl. 701/102

(57) ABSTRACT

An engine control module and method configured to correct an engine crank sensor signal for errors in an apparent location of a tooth edge on a crank wheel is provided. A correction factor is determined based on a first formula if a comparison of adjacent pulse intervals to predetermined thresholds indicates that a tooth edge appears to be abnormally late, and determined based on a second formula if a comparison of adjacent pulse intervals to other predetermined thresholds indicates that a tooth edge appears to be abnormally The correction factor is set to a null value if the correction factor is not determined based on the first formula or the second formula; and operating an engine based on the correction factor.

### TECHNICAL FIELD OF INVENTION

This disclosure generally relates to a method of correcting an engine crank sensor signal for errors in an apparent location of a tooth edge on a crank wheel, and more particularly relates to determining a correction factor for a crank tooth interval affected by such errors.

### BACKGROUND OF INVENTION

Many engines are controlled based on a signal from a crank sensor or crank position sensor in order to properly time engine control events such as fuel injector timing and spark ignition timing. A common way to determine crank position is to equip the engine with a 58-tooth crank wheel, and a crank sensor configured to detect when a tooth of the crank wheel passes by the crank sensor and outputs a corresponding crank signal. The crank signal is typically monitored by an engine control module (ECM) or controller, and used by the ECM to generate timing signals for a fuel injector or an ignition module, for example. However, if the crank wheel becomes damaged, or normal manufacturing variation of the crank wheel is such that an apparent location of a tooth edge on the crank wheel is different than expected (not uniformly spaced with respect to other teeth edge), it may be desirable to correct the crank signal.

### SUMMARY OF THE INVENTION

In accordance with one embodiment, a method of correcting an engine crank sensor signal for errors in an apparent location of a tooth edge on a crank wheel is provided. The method includes determining a first interval value (V1) based on an interval between a first tooth edge (E1) and a second tooth edge (E2). The method further includes determining a second interval value (V2) based on an interval between the second tooth edge (E2) and a third tooth edge (E3). The method further includes determining a third interval value (V3) based on an interval between the third tooth edge (E3) and a fourth tooth edge (E4). The method further includes determining a correction factor (C) for correcting the second interval value (V2). The correction factor (C) is determined based on a first formula if the second interval value (V2) minus the first interval value (V1) is less than a first minimum threshold and the second interval value (V2) minus the third interval value (V3) is less than a second minimum threshold. The correction factor (C) is determined based on a second formula if the second interval value (V2) minus the first interval value (V1) is greater than a first maximum threshold and the second interval value (V2) minus the third interval value (V3) is greater than a second maximum threshold. The correction factor (C) is set to a null value if the correction factor (C) is not determined based on the first formula or the second formula; and operating an engine based on the correction factor (C).

In another embodiment, an engine control module configured to correct an engine crank sensor signal for errors in an apparent location of a tooth edge on a crank wheel is provided. The engine control module is configured to determine a first interval value (V1) based on an interval between a first tooth edge (E1) and a second tooth edge (E2). The engine control module is further configured to determine method further includes determining a second interval value (V2) based on an interval between the second tooth edge (E2) and a third tooth edge (E3). The engine control module is further configured to determine a third interval value (V3) based on an interval between the third tooth edge (E3) and a fourth tooth edge (E4). The engine control module is further configured to determine a correction factor (C) for correcting the second interval value (V2). The correction factor (C) is determined based on a first formula if the second interval value (V2) minus the first interval value (V1) is less than a first minimum threshold and the second interval value (V2) minus the third interval value (V3) is less than a second minimum threshold. The correction factor (C) is determined based on a second formula if the second interval value (V2) minus the first interval value (V1) is greater than a first maximum threshold and the second interval value (V2) minus the third interval value (V3) is greater than a second maximum threshold. The correction factor (C) is set to a null value if the correction factor (C) is not determined based on the first formula or the second formula; and operating an engine based on the correction factor (C).

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a schematic view of an engine equipped with an engine control module in accordance with one embodiment;

FIG. 2 is a graphical illustration of a crank signal from the engine received by the engine control module of FIG. 1 in accordance with one embodiment; and

FIG. 3 is a flow chart of a method executed by the engine control module of FIG. 1 in accordance with one embodiment.

### DETAILED DESCRIPTION

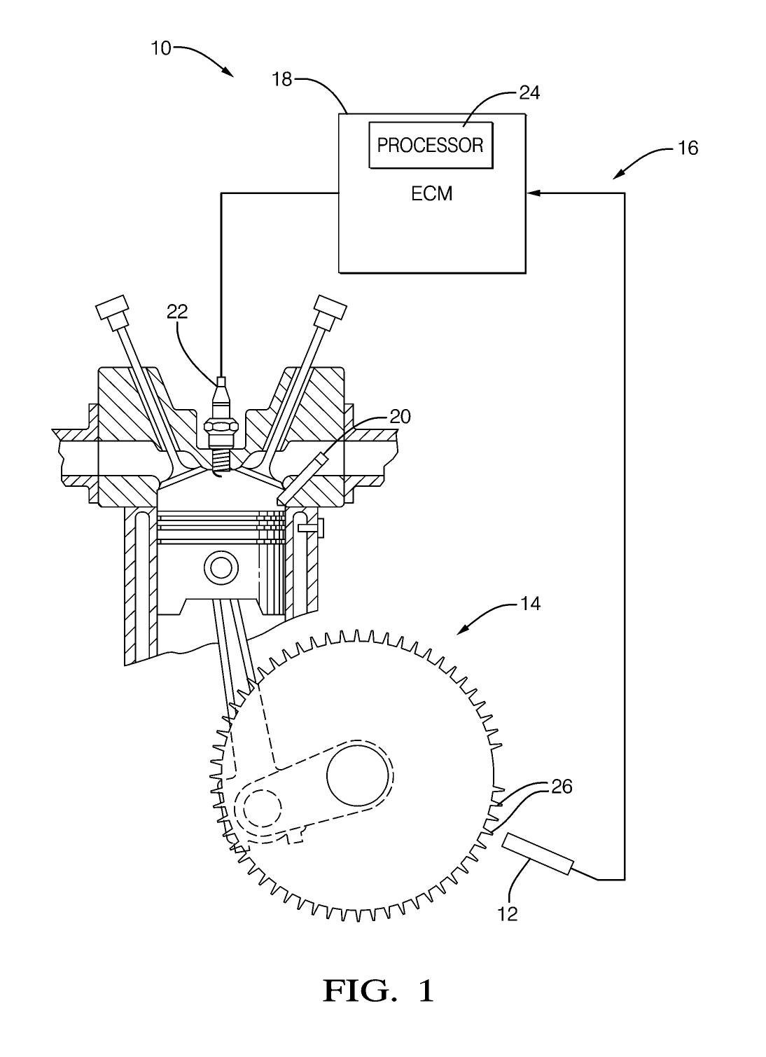

FIG. 1 illustrates a non-limiting example of an engine 10 equipped with a crank sensor 12. The engine 10 is illustrated as a single cylinder engine, however it will be appreciated that the teachings herein are applicable to engines with any number of cylinders. The engine 10 may be equipped with a fifty-eight (58) tooth crank wheel 14. As is commonly known, the fifty-eight teeth are located about every six (6) degrees about the perimeter of the crank wheel 14, and so there is a gap created by a missing fifty-ninth and sixtieth tooth.

The crank sensor 12 is preferably positioned relative to the crank wheel so that the crank sensor 12 outputs a crank signal 16 to an engine control module (ECM) 18 indicative of a tooth or tooth edges 26 of the crank wheel 14 passing by the crank sensor 12. Typically, the ECM 18 uses the crank signal 16 to determine when to perform certain engine control events such as operating a fuel injector 20 or spark plug 22. The crank signal 16 may be a series of square pulses, each pulse corresponding to a single tooth, or may be a sinusoidal type signal (i.e. not square) that is typically post-processed by the ECM 18 in order to convert a non-square waveform into a square type waveform.

The ECM 18 may include a processor 24 such as a microprocessor or other control circuitry as should be evident to those in the art. The ECM 18 may include memory, including non-volatile memory, such as electrically erasable programmable read-only memory (EEPROM) for storing one or more routines, thresholds and captured data. The one or more routines may be executed by the processor to perform steps for determining if the crank signal 16 received by the ECM 18 is abnormal or indicates an error in the crank signal 16 as described herein.

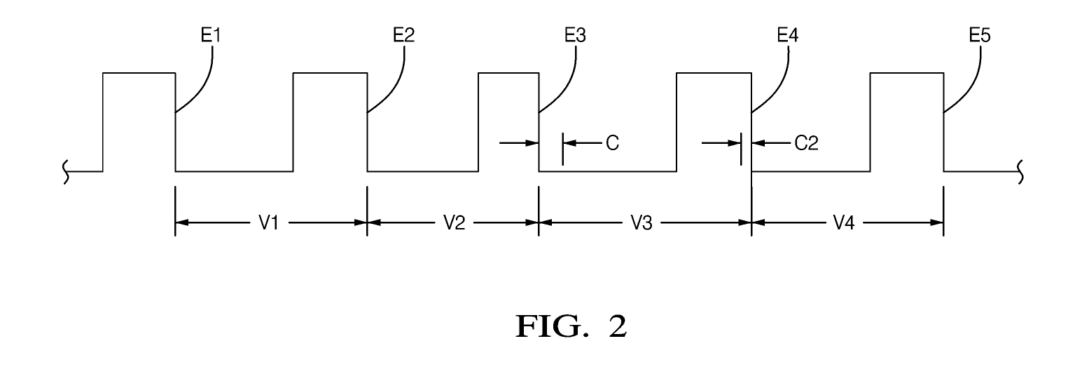

FIG. 2 illustrates a non-limiting example of a crank signal 16 output by the crank sensor 12. In this example, the ECM 18 is configured to detect the falling edges (E1, E2, E3, E4, E5 . . . ) of the crank signal 16 corresponding to various tooth edges 26. It is recognized that the ECM 18 may be alternatively configured to detect the rising edges of the crank signal 16, or detect both the rising and falling edges. As will be explained in more detail below, the ECM 18 or processor 24 is generally configured to detect if there is some abnormality with the crank signal 16 that could be caused by, for example, a damaged or malformed crank wheel 14, or by engine vibration changing a gap distance between the crank wheel 14 and crank sensor 12, and determine a correction factor (C) that can be used to synthesize a more consistent or uniform crank signal 16.

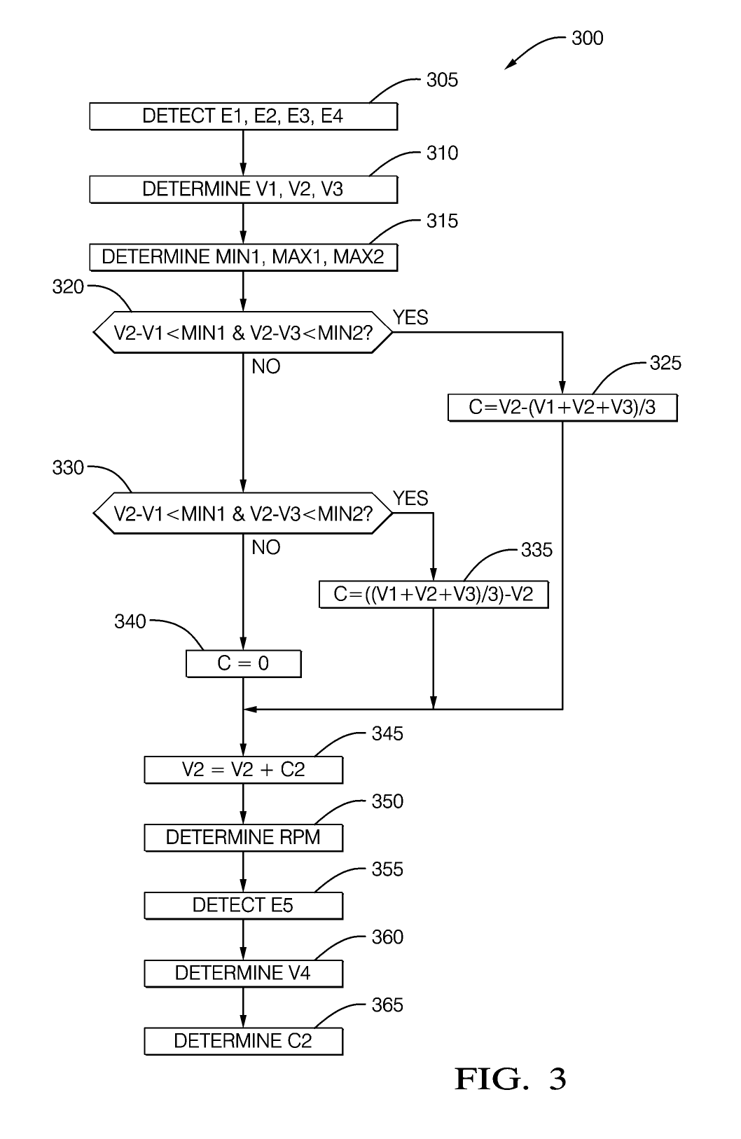

FIG. 3 illustrates a non-limiting example of a method 300 of correcting the engine crank sensor signal 16 for errors in an apparent location of one or more tooth edges 26 on a crank wheel 14, and operating the engine 10 according to the corrected crank signal. In this example, the engine control module (ECM) 18 is generally configured to operate or execute steps according to the method 300 described herein and other methods known to be necessary to control the engine 10.

Step 305, DETECT E1-E4, may include configuring the ECM 18 to detect a falling edge of the crank signal 16 and may include providing circuitry capable of converting a crank signal that is not substantially square in shape to a square wave type signal so detecting a falling edge is more consistent. Such circuitry and signal processing techniques will be evident to those skilled in the art. Step 305 may also include storing the value of a timer operating in the processor 24 or memory (not shown) within the ECM for each edge. Accordingly, it is understood that such timer values are useful to determine or calculate other time based variables. Alternatively, the ECM may be executing a process that provides an estimate of crank angle, and so when each tooth edge (E1, E2, E3, E4, E5 . . . ) is detected, the value corresponding to the estimated crank angle is stored and so is useful to determine or calculate other crank angle based variables.

Step 310, DETERMINE V1-V3, may include determining a first interval value V1 based on an interval between a first tooth edge E1 and a second tooth edge E2. For example, the first interval value V1 may be determined or calculated based on a mathematical difference between the time or crank angle values corresponding to the detecting of the first tooth edge E1 and the second tooth edge E2. Likewise, a second interval value V2 may be determined or calculated based on mathematical difference or an interval between the second tooth edge E2 and a third tooth edge E3, and a third interval value V3 based on an interval between the third tooth edge E3 and a fourth tooth edge E4. It should be apparent that the first interval value V1, the second interval value V2, and the third interval value V3 may be characterized as corresponding to one of time or crank angle depending on the characterization of the stored tooth edge values. By way of example and not limitation, assume that the engine is operating such that the crankshaft is nominally rotating at two thousand five hundred revolutions per minute (2500 RPM). For this engine speed and a crank wheel 14 with teeth nominally located every six degrees, the typical time between successive detected tooth edges is about four hundred microseconds (400 us).

In one embodiment of method 300, detecting errors in an apparent location of one or more tooth edges 26 on a crank wheel 14 may be by way of comparing the differences between various interval values, e.g. V1, V2, V3 to either predetermined thresholds or thresholds determined by some formula that contemplates some engine operating condition. Referring again to FIG. 2, for this example assume that V1=400 us, V2=375 us, and V3=425 us. For this example it would appear that E3 was abnormally early, and so V3 may need to be corrected.

Step 315, DETERMINE MIN1, MIN2, MAX1, MAX2, may include determining the first minimum threshold (MIN1), the second minimum threshold (MIN2), the first maximum threshold (MAX1), and the second maximum threshold (MAX2) in a laboratory setting and then preprograming the ECM 18 with fixed predetermined values. It may be suitable for MIN1 and MIN2 to be equal, and it may be suitable for MAX1 and MAX2 to be equal, as would be learned through empirical testing of the particular engine being calibrated. It is also recognized that it may be suitable for MIN1, MIN2, MAX1, and MAX2 to all be equal in magnitude. Through empirical testing it may be determined that a suitable threshold for separating a crank signal error caused by an actual flaw in the crank wheel 14 from a crank signal error caused by uncontrollable noise is five percent (5%), and so for this case a time threshold of twenty microseconds (20 us) or a crank angle threshold of zero point three degrees of crank angle (0.3 CAD) would be suitable. As such, it may be suitable to set MIN1=MIN2=−20 us, and MAX1=MAX2=20 us.

Alternatively, it has been suggested that the overall performance of the method 300 may be improved by determining or calculating various thresholds based on certain engine operating conditions. For example, at higher engine speeds, five thousand revolutions per minute (5000 RPM) for example, it may be that a suitable threshold is three percent (3%) and so the time interval threshold is six microseconds (bus) or a crank angle threshold of zero point one eight crank angle degrees (0.18 CAD) is suitable.

It has also been suggested that the thresholds may be unequal in certain conditions. For example, if the engine is accelerating or decelerating, or even if the engine is pulling a load versus coasting, it may be preferable to determine or calculate distinct values for each of the thresholds. In the case of acceleration, it is expected that V2 will be smaller than V1 (speeding up lessens the nominal V2 time compared to V1), and that V3 will be smaller than V2. By way of example and not limitation, assume that the engine 10 is accelerating at twenty revolutions per second per second (20 R/ŝ2), and the average engine speed over the three intervals is 2500 RPM For this example, a suitable first minimum threshold MIN1 may be −22 us, while a suitable second minimum threshold MIN2 may be −22 us. Likewise, suitable values for the first maximum threshold MAX1 may be 18 us and the second maximum threshold MAX2 may be 18 us. Acceleration may be determined by solving s=u(t)+a(t̂2)/2, where s=displacement in teeth, u=initial velocity in teeth/second, and a=acceleration in teeth/(second̂2). Compensating or adjusting for acceleration may be advantageous to compensate for normal combustion cycle torque/acceleration (i.e.—cylinder pulsations), or general acceleration such as engine speed changes due to throttle position change, transmission shifting, rough road operation, etc.

Once the various thresholds are determined, the method 300 can proceed to determining if the various interval values indicate that there is a substantial error in the crank signal, and determining what correction factor should be applied to the interval value that appears to have an error. For this non-limiting example, let the values of MIN1=MIN2=−20 us, and MAX1=MAX2=20 us.

Step 320, V2−V1<MIN1 & V2−V3<MIN2, may include determining or calculating differences between the various interval values, and comparing those values to the various thresholds. By way of example and not limitation, Step 320 may test if the second interval value V2 minus the first interval value V1 is less than a first minimum threshold MIN1 and the second interval value V2 minus the third interval value V3 is less than a second minimum threshold MIN2. If a logical answer to this test is YES, it may be an indication that the second interval value V2 is substantially greater than both the first interval value V1 and the third interval value V3 and so caused by an error in determining, for example, the location of the third tooth edge as suggested in FIG. 2, and not likely caused by a sudden acceleration and deceleration of the crank wheel 12 causing the second interval V2 to be less than expected. If the logical answer to step 320 is YES, then the method proceeds to step 325. If NO, the method 300 proceeds to step 330. For the example values given above, the logical answer to 425 us−400 us<−20 us and 425 us−375 us<−20 us would be NO, and so for this example the method 300 proceeds to step 330.

Step 325, C=V2−(V1+V2+V3)/3, may include determining or calculating a correction factor C (FIG. 2) for correcting the second interval value V2 based on a first formula. For example, the first formula may determine correction factor C by calculating the second interval value V2 minus an average value of the first interval value V1, the second interval value V2, and the third interval value V3. It is recognized that other formulas for determining the correction factor are feasible. For example, and average of more than the three interval values suggest, or a root-mean-square value of any number of interval values.

Step 330, V2−V1>MAX1 & V2−V3>MAX2, is similar to Step 320, except that it checks to see if the second interval value V2 is excessively large when compared to the first interval value V1 and the third interval value V3. For example, Step 330 may determine if the second interval value (V2) minus the first interval value (V1) is greater than a first maximum threshold MAX1 and the second interval value (V2) minus the third interval value (V3) is greater than a second maximum threshold MAX2. If the logical answer to step 330 is YES, then the method proceeds to step 335. If NO, the method 300 proceeds to step 340. For the example values given above, the logical answer to 425 us−400 us>20 us and 425 us−375 us>20 us would be YES, and so for this example the method 300 proceeds to step 335.

Step 335, C=((V1+V2+V3)/3)−V2, may include the correction factor C being determined or calculated based on a second formula. A non-limiting example of the second formula determines the correction factor C to be equal to an average value of the first interval value, the second interval value V2 and the third interval value V3, minus the second interval value V2. For the example values given above, the correction factor C is calculated to be ((400 us+425 us+375 us)/3)−425 us=−25 us. Since a correction factor C was calculated, the method 300 would proceed to step 345.

Step 340, C=0, may include setting the correction factor (C) to a null value such as zero (0) if the logical answer to both steps 320 and 330 are NO, and so the correction factor (C) is not calculated based on the first formula or the second formula. Zero is given as a non-limiting example, and it is recognized that other values may be necessary to be the null value if certain binary math techniques are used by the ECM 18 or processor 24.

Step 345, V2=V2+C, may include replacing the second interval value V2 previously stored by the ECM 18 or processor 24 with a corrected value that increases that stored value by an amount corresponding to the correction factor C. Alternatively, the second interval value V2 may remain unchanged, but the correction factor C may be used by the ECM 18 or processor 24 when making certain timing calculations for operating the engine 10. For the example values given above, the second internal value would be corrected to be V2 (corrected)=425 us+(−25 us)=400 us.

Step 350, DETERMINE RPM, is an optional step that may be performed if the second correction value C for a given interval value varies with engine speed. If the second correction value C does vary with engine speed, it may be necessary to calculate and store a table or list of correction values that vary with engine speed. While not subscribing to any particular theory, it has been suggested that variation of the second correction value C with engine speed may be caused by engine imbalances or vibrations. As such, it may be advantageous to determine the correction factor C at various engine speeds, and classify various values of the correction factor C according to the engine speed.

The following steps may be performed to determine a second correction factor (C2) based on subsequent tooth pulses.

Step 355, DETECT E5, may include detecting a subsequent falling edge (E5)

Step 360, DETERMINE V4, may include determining a fourth interval value (V4) based on an interval between the fourth tooth edge (E4) and a fifth tooth edge (E5)

Step 365, DETERMINE C2, may include determining a second correction factor (C2) for correcting the third interval value (V3), wherein the second correction factor (C2) is calculated based on a third formula if the third interval value (V3) minus the second interval value (V2) minus the correction factor (C) is less than the first minimum threshold and the third interval value (V3) minus the fourth interval value (V4) is less than the second minimum threshold, the second correction factor (C2) is calculated based on a fourth formula if the third interval value (V3) minus the second interval value (V2) minus the correction factor (C) greater than the first maximum threshold and the third interval value (V3) minus the fourth interval value (V4) is greater than the second maximum threshold, and the second correction factor (C2) is set to a null value if the second correction factor (C2) is not calculated based on the third formula or the fourth formula; and operating an engine based on the second correction factor (C2).

Accordingly, an engine control module (ECM) 18 and a method 300 of correcting an engine crank sensor signal for errors in an apparent location of a tooth edge on a crank wheel is provided. The method 300 advantageously corrects crank signal errors using just the previous and subsequent interval values, and so is able to provide a corrected interval value (e.g. a corrected V2) faster than algorithms that examine large amounts of interval data to make crank signal error corrections.

While this invention has been described in terms of the preferred embodiments thereof, it is not intended to be so limited, but rather only to the extent set forth in the claims that follow.

We claim:

1. A method of correcting an engine crank sensor signal for errors in an apparent location of a tooth edge on a crank wheel, said method comprising:
determining a first interval value (V1) based on an interval between a first tooth edge (E1) and a second tooth edge (E2);
determining a second interval value (V2) based on an interval between the second tooth edge (E2) and a third tooth edge (E3);
determining a third interval value (V3) based on an interval between the third tooth edge (E3) and a fourth tooth edge (E4);
determining a correction factor (C) for correcting the second interval value (V2), wherein the correction factor (C) is determined based on a first formula if the second interval value (V2) minus the first interval value (V1) is less than a first minimum threshold and the second interval value (V2) minus the third interval value (V3) is less than a second minimum threshold, the correction factor (C) is determined based on a second formula if the second interval value (V2) minus the first interval value (V1) is greater than a first maximum threshold and the second interval value (V2) minus the third interval value (V3) is greater than a second maximum threshold, and the correction factor (C) is set to a null value if the correction factor (C) is not determined based on the first formula or the second formula; and
operating an engine based on the correction factor (C).

2. The method in accordance with claim 1, wherein the first interval value (V1), the second interval value (V2), and the third interval value (V3) are characterized as corresponding to one of time and crank angle.

3. The method in accordance with claim 1, wherein the first formula is based on an average value of the first interval value (V1), the second interval value (V2), and the third interval value (V3).

4. The method in accordance with claim 3, wherein the first formula determines the correction factor (C) to be equal to the second interval value (V2) minus an average value of the first interval value (V1), the second interval value (V2), and the third interval value (V3).

5. The method in accordance with claim 1, wherein the second formula is based on an average value of the first interval value (V1), the second interval value (V2), and the third interval value (V3).

6. The method in accordance with claim 5, wherein the second formula determines the correction factor (C) to be equal to an average value of the first interval value (V1), the second interval value (V2) and the third interval value (V3), minus the second interval value (V2).

7. The method in accordance with claim 1, wherein method includes determining an engine speed, and the step of determining the correction factor (C) includes classifying the correction factor (C) according to the engine speed.

8. The method in accordance with claim 1, wherein the first minimum threshold and the second minimum threshold are equal.

9. The method in accordance with claim 1, wherein the first maximum threshold and the second maximum threshold are equal.

10. The method in accordance with claim 1, wherein the first minimum threshold and the second minimum threshold differ by an amount based on an acceleration rate of the vehicle.

11. The method in accordance with claim 1, wherein the first maximum threshold and the second maximum threshold differ by an amount based on an acceleration rate of the vehicle.

12. The method in accordance with claim 1, wherein the method further comprises
determining a fourth interval value (V4) based on an interval between the fourth tooth edge (E4) and a fifth tooth edge (E5);
determining a second correction factor (C2) for correcting the third interval value (V3), wherein the second correction factor (C2) is determined based on a third formula if the third interval value (V3) minus the second interval value (V2) minus the correction factor (C) is less than the first minimum threshold and the third interval value (V3) minus the fourth interval value (V4) is less than the second minimum threshold, the second correction factor (C2) is determined based on a fourth formula if the third interval value (V3) minus the second interval value (V2) minus the correction factor (C) greater than the first maximum threshold and the third interval value (V3) minus the fourth interval value (V4) is greater than the second maximum threshold, and the second correction factor (C2) is set to a null value if the second correction factor (C2) is not determined based on the third formula or the fourth formula; and
operating an engine based on the second correction factor (C2).

13. An engine control module configured to operate according to claim 1.
